(19) United States
(12) Patent Application Publication
(10) Pub. No.: US 2008/0304407 A1
(43) Pub. Date: Dec. 11, 2008

(54) Efficient Protection Mechanisms For Protecting Multicast Traffic in a Ring Topology Network Utilizing Label Switching Protocols

(75) Inventors: Igor Umansky, Petach Tikva (IL); Gilad Goren, Nirit (IL)

Correspondence Address: SUGHRUE MION, PLLC, 2100 PENNSYLVANIA AVENUE, N.W., SUITE 800, WASHINGTON, DC, 20037, US

(73) Assignee: ALCATEL TELECOM ISRAEL, Petah Tikva (IL)

(21) Appl. No.: 11/575,357

(22) PCT Filed: Sep. 15, 2005
(86) PCT No.: PCT/IL2005/000986

§ 371 Date: Jul. 10, 2008

Related U.S. Application Data
(60) Provisional application No. 60/610,184, filed on Sep. 16, 2004.

(51) Int. Cl. G06F 11/07

(52) U.S. Cl. 370/222

(57) ABSTRACT

Efficient protection mechanisms for ring-based label-switching networks, such as multi-protocol label switching (MPLS) networks. The protection mechanisms are designed to protect point-to-multipoint label switching paths (LSPs). In steering ring protection embodiments, the nodes of the ring network are provided with pre-configured tables that enable each node to operate in both working mode and protection mode. The information required for each node to switch between the two modes in included in its respective table during the pre-configuration of the ring network. In wrapping ring protection embodiments, the wrapping is performed by assigning a unique LSP label to each LSP and further configuring each intermediate node in the ring network to transparently pass data packets including the unique LSP label. Upon detecting a failure in a network node, the data packets including the unique LSP label are switched to a protection ring.

The invention is based on a priority application U.S. 60/610,184 which is hereby incorporated by reference.

### FIELD OF THE INVENTION

The present invention relates generally to label switching networks, and more particularly to a method and system for providing failure protection in a ring topology network that utilizes label-switching protocols.

### BACKGROUND OF THE INVENTION

The label switching technique was developed to expedite the look-up process at each network node as packets travel from a source to a destination. Abstractly, label switching involves attaching a label to a packet that enables the next node (i.e., hop) of the packet to be quickly determined by an intermediate network node that receives the packet. An example for such a label switching protocol is the multi-protocol label switching (MPLS) protocol.

In a MPLS network, a label is assigned to each incoming packet by a label edge router (LER). Packets are forwarded along a label switch path (LSP) where each label switch router (LSR) makes forwarding decisions based solely on the contents of the label. At each hop, the LSR may swap the label to a new label that instructs the next LSR how to forward the packet. LSPs are established by network operators for a variety of purposes including guaranteeing a certain level of performance or routing packets around network congestions or failures.

Ring topology networks are now being adapted to carry packet-switched traffic and label switching is being implemented on the ring networks to provide improved quality of service (QoS) and reliability. To maintain transmission in an event of a failure, ring topology networks in which traffic is transmitted in two directions are commonly used. Specifically, transmissions occur in one direction in a working path and through an opposite direction in a protection path.

FIG. 1 shows an exemplary diagram of a fiber-optic ring network 100, which comprises six nodes (e.g., LSRs) 110-1 through 110-6 connected to fibers 120 and 130. Fiber 120 transports traffic in a working path and fiber 130 occasionally transports traffic in a protection path. Traffic travels on the protection path and the working path in opposite directions. Typically, there are two types of optical ring protection networks: a bidirectional ring network and a unidirectional ring network. In a unidirectional ring network, only one optic fiber (e.g., fiber 120) carries working traffic to be protected while the other fiber (e.g., fiber 130) is dedicated for protecting this traffic. In a bidirectional ring network, each fiber (i.e., fiber 120 or 130) carries working and protection traffic. Network 100 may be, but is not limited to, a synchronous optical network (SONET), a synchronous digital hierarchy (SDH) network, a resilient packet rings (RPR) network, and the like. Typically, a fault in network 100 may occur due to a failure of a segment in fiber 120 or a failure of one of nodes 110. In case of such a failure (shown schematically by X), a protection is performed by switching traffic from the working path to the protection path to bypass the failed node or segment. The term “wrapping” refers to the switching performed on the traffic to route it from one path to another. That is, when there is a protection switch, a node wrapping LSP traffic from a working to protection path. The figure shows such wrapping occurring at node 110-2 upon a failure between nodes 110-2 and 110-3.

Another technique for providing traffic protection is known as steering. In networks with long transmission paths and with a large number of the network elements, the approach of wrapping protection rings is insufficient. For some types of failures, the wrapping approach in a MPLS-shared protection ring may lead to long restoration transmission paths. FIG. 2A shows a ring topology network 200 in which traffic belonging to LSP ‘Q’ travels from a source node A to a destination node B on a working ring 220. The bandwidth on each of working ring 220 and a protection ring 230 span is divided, so part of ring capacity is dedicated to the working traffic and part is dedicated to the protection traffic. The protection bandwidth in one direction is used to carry the working traffic from the other direction in case of a failure. FIG. 2B shows the rerouting of the traffic in response to a fiber cut. When a ring switch occurs, all LSPs affected by the failure are bridged at their source nodes onto the protection bandwidth that travels on nodes that do not cross the point of failure. When the affected LSPs reach their final destination nodes, they are switched to their original drop points. This is accomplished by using the ring topology connections maps and a proprietary protocol. For example, if a failure occurs in a segment of fiber that links neighboring nodes 210-B and 210-C, the traffic of LSP ‘Q’ is switched to protection ring at a source node 210-A and travels through nodes 210-F and 210-E to a destination node 210-D.

A MPLS shared protection ring in a steering application can use MPLS tunnel sub-layer indications or lower layers indications to trigger the protection switching, A switching action is performed only on LSPs affected by a failure. In the event of a failure, ring switches are established at any node whose traffic is affected by the failure. Unlike the MPLS wrapping ring techniques, no loop-backs are established in this case.

The wrapping and steering techniques as demonstrated above are mainly utilized for protection of uni-cast traffic. These techniques are not normally adapted to support multicast traffic protection. The conventional packet-switching solutions reroute traffic by reconfiguring routing paths, i.e., by reconfiguring forwarding tables of the nodes in a network between the source and the destination. For example, U.S. Pat. No. 6,532,088 discloses a system and method for packet level distributed routing in a fiber-optic ring network including two rings. One ring is for conducting the user traffic on a working path and the other ring is for conducting the same user traffic on a protection path in the event of a failure in a communication link in the first ring. A central node is coupled to a plurality of nodes to provide forwarding tables and updates to the nodes. As a result, Internet protocol (IP) traffic may be routed through the fiber-optic ring network in a manner that provides fast switching from a working path to a protection path to minimize lost data packets, whenever a communication link in the working path fails. The forwarding tables are also set up to support multicast transmissions of data packets. The main disadvantages of the solution disclosed in U.S. Pat. No. 6,532,088 are that the central node is the only source for providing the forwarding tables and that updated forwarding tables are provided only when a failure is detected. This results in non-deterministic and usually intolerably long completion times for restoring traffic in a case of protection. Furthermore, for any oriented packet switching protocol (such as in a MPLS network) based on a ring topology, there is no standard or any known technique that specifies the protection mechanism, requirements and network objectives to be used. It would be therefore advantageous to provide efficient protection mechanisms for ring topology networks that are based on label switching protocols. It would be further advantageous to provide efficient protection mechanisms for protecting multicast traffic.

### SUMMARY OF THE INVENTION

According to the present invention there is provided, in a ring network that includes a working transport medium and a protection transport medium, a method for protecting multicast traffic of a LSP established between a source node and a destination node through at least one intermediate node, the method comprising the steps of: pre-configuring each node with a respective table operative to instruct the node on actions to be taken upon detection of a failure in the ring network and upon detection of the failure in the ring network, causing at least one node to perform a protection action on the multicast traffic according to its respective preconfigured instructions, wherein the method is particularly applicable to steering ring protection.

According to one feature in the method a method for protecting multicast traffic of a LSP of the present invention, the step of pre-configuring includes: pre-configuring the source node with a protection routing table (PRT) operative to reroute the multicast traffic, and pre-configuring each intermediate node and the destination node with a respective protection forwarding table (PFT) operative to provide at least an alternative forwarding action.

According to another feature in the method a method for protecting multicast traffic of a LSP of the present invention, the step of causing at least one node to perform a protection action is preceded by the step of sending, by a node that detects the failure, a failure status message to each other node.

According to another feature in the method a method for protecting multicast traffic of a LSP of the present invention, the step of sending includes, by the source node and according to its PRT, rerouting the multicast traffic and, by each intermediate node and according to its respective PFT, performing a forwarding action on the multicast traffic.

According to another feature in the method a method for protecting multicast traffic of a LSP of the present invention, the rerouting of the multicast traffic by the source node includes switching the traffic to the protection transport medium.

According to another feature in the method a method for protecting multicast traffic of a LSP of the present invention, the detection of the failure is performed by an immediate neighboring node adjacent to a location of the failure, and wherein the step of sending by a node that detects the failure includes sending a failure location message by the immediate neighboring node.

According to another feature in the method a method for protecting multicast traffic of a LSP of the present invention, the rerouting of the multicast traffic by the source node further includes performing an operation selected from the group consisting of uni-casting traffic and bi-casting traffic.

According to another feature in the method a method for protecting multicast traffic of a LSP of the present invention, the performing a forwarding action on the multicast traffic includes performing a forwarding action selected from the group consisting of a drop action, a forward action and a drop-and-forward action.

According to another feature in the method a method for protecting multicast traffic of a LSP of the present invention, the performing of a drop-and-forward action includes replicating data packets of the multicast traffic internally in an intermediate node that receives the packets; sending the replicated data packets to at least one customer site connected to the respective intermediate node, and sending the data packets to a next node connected to the respective intermediate node.

According to another feature in the method a method for protecting multicast traffic of a LSP of the present invention, the performing a drop action includes: sending data packets of the multicast traffic to at least one customer site connected to an intermediate node or to the destination node.

According to another feature in the method a method for protecting multicast traffic of a LSP of the present invention, the performing of a forward action includes sending data packets of the multicast traffic to a neighboring node the ring network.

According to another feature in the method a method for protecting multicast traffic of a LSP of the present invention, the step of pre-configuring includes pre-configuring by an operator using a mechanism selected from the group consisting of a network management system, a command line interface and a signaling protocol.

According to another feature in the method a method for protecting multicast traffic of a LSP of the present invention, the step of pre-configuring the source node with a PRT includes pre-configuring the PRT with at least one alternate path for the LSP.

According to another feature in the method a method for protecting multicast traffic of a LSP of the present invention, the step of pre-configuring each intermediate node and the destination node with a respective PRT pre-configuring a forwarding action to be performed for each instance of failure.

In some embodiments of the method of the present invention, the method further comprises the steps of creating at least one protection tunnel over the protection transport medium to carry normal traffic, creating at least one working tunnel over said working transport to carry multicast traffic.

In some embodiments of the method of the present invention, the step of causing at least one node to perform a protection action on the multicast traffic includes transmitting the multicast traffic in opposite direction from the failure location over the protection tunnel, and dropping the multicast traffic at the destination node.

According to the present invention there is provided, in a ring network that includes a working transport medium and a protection transport medium, a system for protecting multicast traffic of a LSP established between a source node and a destination node through at least one intermediate node, the system comprising a pre-configured table included in each node of the ring network and operative to instruct the node on actions to be taken upon detection of a failure in the ring network and a mechanism for performing at least at one node a protection action on the multicast traffic according to instructions in its respective pre-configured table.

According to one feature in the system a method for protecting multicast traffic of a LSP of the present invention, a preconfigured table includes, for the source node, a PRT operative to reroute the multicast traffic, and for each intermediate and destination node a PFT operative to provide an alternative forwarding action.

According to another feature in the system a method for protecting multicast traffic of a LSP of the present invention, the source node PRT instructions include instructions to perform an operation selected from the group consisting of uni-casting traffic and bi-casting traffic.

According to another feature in the system a method for protecting multicast traffic of a LSP of the present invention, the intermediate node PFT instructions include a forwarding action selected from the group consisting of a drop action, a forward action and a drop-and-forward action.

According to another feature in the system a method for protecting multicast traffic of a LSP of the present invention, the ring network is operative to use a label switching protocol for transferring data packets.

According to another feature in the system a method for protecting multicast traffic of a LSP of the present invention, the label switching protocol includes a MPLS protocol.

According to another feature in the system a method for protecting multicast traffic of a LSP of the present invention, the ring network is selected from the group consisting of a unidirectional ring network and a bidirectional ring network.

According to the present invention there is provided in a ring network that includes a working transport medium and a protection transport medium, a method for protecting multicast traffic of a LSP established between a source node and a destination node through at least one intermediate node, the method comprising the steps of assigning a unique LSP label for the LSP, configuring each intermediate node in the ring network to transparently transfer data packets of the multicast traffic, each data packet including the unique LSP label, and, upon detecting a failure in the ring network, switching the data packets to a protection transport medium.

### BRIEF DESCRIPTION OF THE DRAWINGS

For a better understanding of the present invention and to show more clearly how it could be applied, reference will now be made, by way of example only, to the accompanying drawings in which:

FIG. 1 is an exemplary diagram of a fiber-optic ring network utilizing a MPLS protocol;

FIG. 2A shows a the principles of protection mechanism for a ring network ring that utilizes the packet steering technique;

FIG. 2B shows the procedure used in the topology of FIG. 2A in case of a failure;

FIG. 3A shows schematically the principles of a wrapping ring protection mechanism for multicast traffic according to the present invention;

FIG. 3B shows a failure occurring in a fiber segment in a working transport medium of the ring network of FIG. 3A;

FIG. 4A shows schematically the principles of a steering ring protection mechanism for multicast traffic according to the present invention;

FIG. 4B shows a failure occurring in a fiber segment of the ring topology network of FIG. 4A;

FIG. 4C shows an exemplary block diagram of a node in the ring topology network of FIG. 4A;

FIG. 5 is a non-limiting flowchart describing the method for performing steering ring protection for multicast traffic;

FIGS. 6A-C shows exemplary protection routing table (A) and protection forwarding tables (B-C);

FIG. 7 is a non-limiting illustration of the protection architecture for two MPLS rings with a signal routed in the same direction in both rings; and

FIG. 8 is a non-limiting illustration of the protection architecture for two MPLS rings with a signal routed in the opposite directions in both rings.

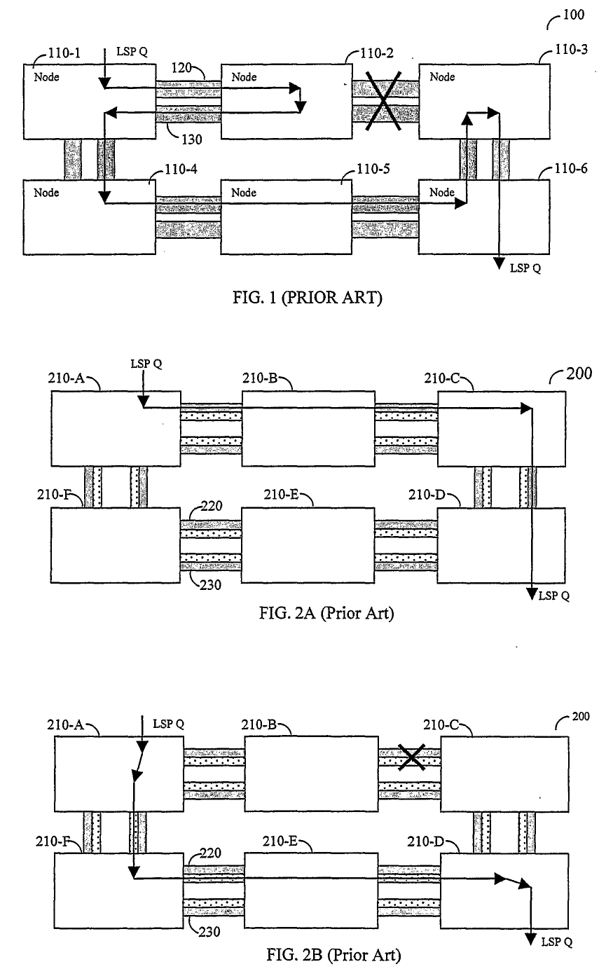

### DETAILED DESCRIPTION OF THE PREFERRED EMBODIMENTS

The present invention discloses a system and method for protecting multicast traffic of a label switched path. The system and method provide efficient protection mechanisms for ring-based label-switching networks, such as MPLS networks. The protection mechanisms are designed to protect point-to-multipoint labeled switch paths by utilizing uni-cast protection techniques, such as wrapping and steering. Also disclosed are protection mechanisms for dual ring networks.

In system and method embodiments as applied to wrapping ring protection, a multicast traffic of a LSP is switched from a working transport medium in a ring to a protection transport medium in the ring. The switch of traffic is performed without changing the forwarding actions of the nodes. This is achieved by assigning a unique label for each LSP and by further configuring each intermediate node in the ring network to transparently pass data packets including the unique LSP label.

In system and method embodiments as applied to steering ring protection, the nodes of the ring network are provided with pre-configured tables that enable each node to operate in both working mode and protection mode. The information required for each node to switch between the two modes in included in its respective table during the pre-configuration. Upon detection of a failure, advantageously and in contrast with prior art, these tables do not need any reconfiguration in order to switch from the working mode to the protection mode.

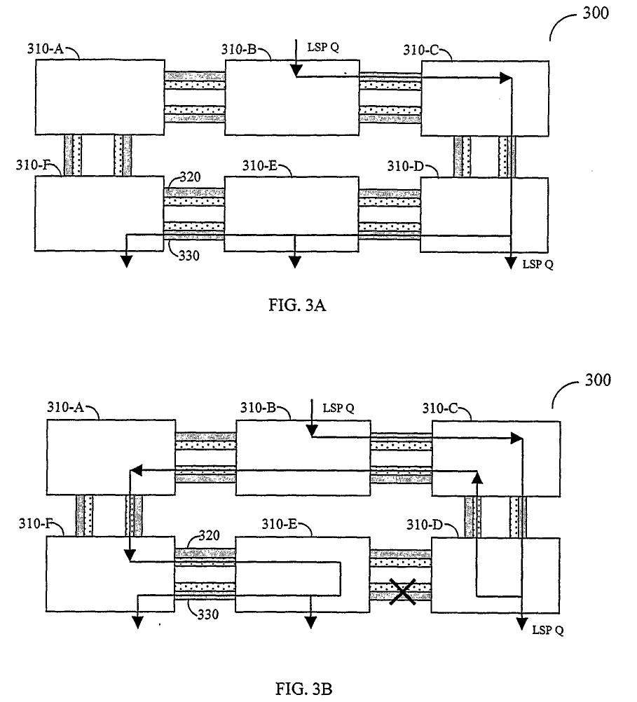

FIG. 3A shows a non-limiting illustration of a ring topology network 300 used for demonstrating the principles of wrapping ring protection switching for multicast traffic according to the present invention. The topology includes a working transport medium 320 and a protection transport medium 330. The bandwidth on each of working transport medium 320 and protection transport medium 330 span is divided. The protection bandwidth in one direction is used to carry the working traffic from the other direction in case of a failure. In the example provided in FIG. 3A, the traffic of LSP ‘Q’ is multicast traffic, targeted to nodes 310-D, 310-E and 310-F. For that purpose, a node 310-C is configured to perform a “forward” action, nodes 310-D and 310-E are configured to perform a “drop-and-forward” action and node 310-F is configured to perform a “drop” action on the LSP-Q traffic. The “drop” functionality is shown by small arrows exiting each box. Specifically, the “forward” action essentially refers to sending incoming packets directly to an adjacent node, the “drop” action essentially refers to sending incoming packets to at least one customer site connected to the node, and the “drop-and-forward” action essentially refers to sending a copy of each incoming packet to least one customer site and forwarding the packet to an adjacent node

FIG. 3B shows a failure occurring in working transport medium 320, in a fiber segment that connects nodes 310-D and 310-E. As a result, the LSP-Q traffic is restored at every node by wrapping the traffic to protection transport medium 330. The wrapping is performed at a node adjust to the point of failure, i.e., node 310-D. It should be noted that each node performs the same function as prior to the failure, i.e., no reconfiguration due to protection switching is required. In an embodiment of the present invention, the wrapping is performed by assigning a unique LSP label to each LSP, and further configuring each intermediate node in the ring network to transparently pass data packets including the unique LSP label. Upon detecting a failure in a network node 310, the data packets including the unique LSP label are switched to a protection ring. A technique for assigning unique LSP labels to each LSP is disclosed in PCT application PCT/IL05/000464 (hereinafter the “'464 application”), assigned in common to the same assignee as the present application, and which is hereby incorporated by reference.

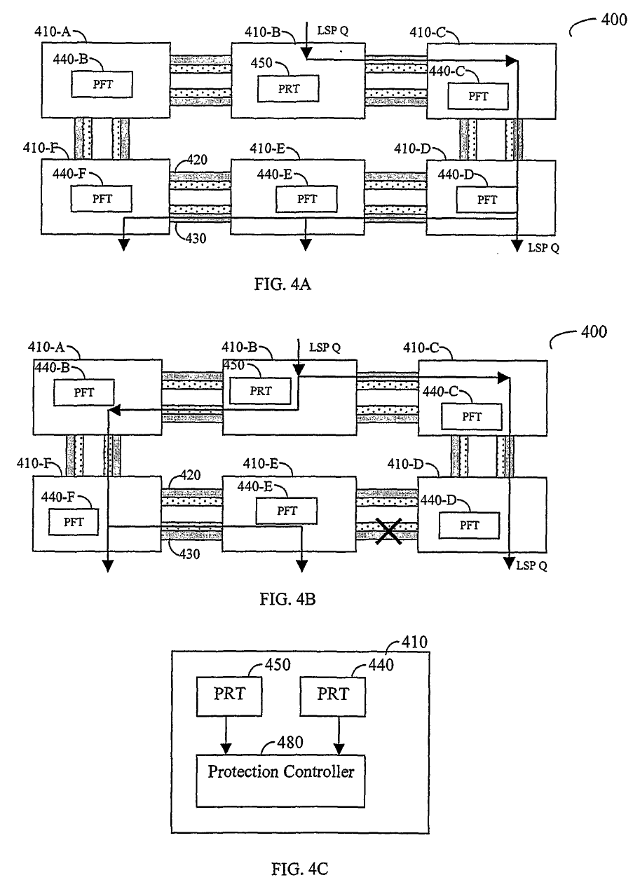

FIG. 4A shows a non-limiting illustration of a ring topology network 400 used for demonstrating the principles of steering ring protection for multicast traffic according to one embodiment of the present invention. The topology includes a working transport medium 420 and a protection transport medium 430, passed through six nodes 410-A through 410-F. Traffic belonging to LSP ‘Q’ is added by node 410-B to the ring and sent to nodes 410-D, 410-E and 410-F. For that purpose, node 410-C is configured to “forward”, nodes 410-D and 410-E are configured to “drop-and-forward” and node 410-F is configured to “drop” the LSP-Q traffic. An exemplary block diagram of a node 410 is shown in FIG. 4C. Each node 410 includes a protection controller 480 and a respective preconfigured table (at least one of PRT 440 or PFT 450), examples of which are shown in FIG. 6. Protection controller 480 performs a protection action on the multicast traffic according to instructions in its respective pre-configured table. Specifically, the source node of the LSP (e.g., node 410-B) has a preconfigured protection routing table (PRT) 450, which is used to indicate how traffic should be transmitted on the ring in a case of failure. The information required for the action is included in the table itself, requiring no re-configuration. All other (intermediate and destination) nodes have each their own preconfigured protection forwarding table (PFT) 440. PFT 440 includes the forwarding action to be performed responsive to a detected failure.

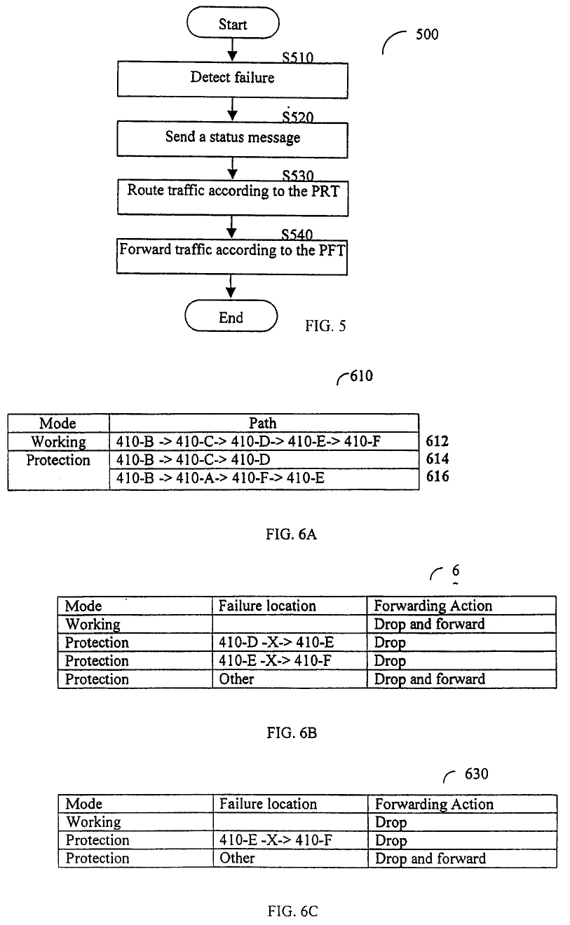

FIG. 4B shows a failure occurring in a fiber segment that links nodes 410-D and 410-E. In order to restore the LSP-Q traffic, nodes 410-B, 410-D, 410-E and 410-F must be instructed to perform forwarding action with LSP-Q different from normal state. Specifically, node 410-B bi-casts (i.e., casts bi-directionally or transmits packets to two directions) LSP-Q packets. That is, packets are sent both to node 410-D through node 410-C and to nodes 410-E and 410-F via node 410-A. Furthermore, the routing function performed by each mode is modified. Nodes 410-E and 410-D perform “drop” instead of performing “drop and forward” on the packets, and node 410-F performs “drop-and-forward” instead of “drop” packets. This is a complex network operation, which should be synchronized between different nodes, and achieved using the protection method described in FIG. 5.

FIG. 5 shows a non-limiting flowchart 500 describing the method for performing steering ring protection for multicast traffic in accordance with an exemplary embodiment of the present invention. In S510, a failure is detected in the ring by one of the nodes adjacent to the point of failure. A failure of a link utilized by a working LSP may include a fiber cut or an unacceptable degradation in the quality of service, such as an unacceptably high bit error rate (BER) or latency. Failures can be detected by any technique known in the art and the specific failure detection technique used is not critical to the invention. In S520, a node that detects the failure sends a status message to all other nodes in the ring. The status message notifies each node including a source node on the point of failure relative to the LSP.

In S530, upon receiving the status message, the source node reroutes incoming traffic of the LSP according to its own preconfigured PRT (e.g., PRT 450). For example, FIG. 6A shows an exemplary PRT 610 of node 410-B. PRT 610 includes information on the paths for working (i.e., normal) and protection modes of operation. In a normal mode, there is a LSP path 612 from node 410-C to node 410-F through nodes 410-D and 410-E. In a protection mode, incoming traffic is bi-cast to nodes 410-C and 410-A and sent through paths 614 and 616. In path 614, traffic from node 410-C is forwarded to node 410-D and in path 616, traffic from node 410-A is forwarded to nodes 410-F and 410-E. Note that traffic to node 410-D is sent over working transport medium 420 and packets to nodes 410-E and 410-F are transmitted over protection transport medium 430.

In S540, each intermediate node (i.e., all nodes that are not source or destination of the LSP) handles incoming packets of the LSP according to its preconfigured PFT (e.g., one of PFTs 440). An exemplary table shows the content of a PFT 620 of node 410-E in provided in FIG. 6B. According to PFT 620, in a working mode, node 410-E is configured to perform “drop and forward” action. In a protection mode, it is configured to drop packets if a failure is detected either in a link between nodes 410-D and 410-E or in a segment between nodes 410-F and 410-E. In other cases of failure affecting LSP-Q (e.g., of a failure on the link between nodes 410-C and 410-D) node 410-E performs a “drop and forward” operation.

As another example, FIG. 6C shows the PFT 630 of node 410-F. In the working mode, is configured to drop packets. In the protection mode, node 410-F drops packets only if the failure is in the segment between nodes 410-E and 410-F. At all other locations, the forwarding action is drop-and-forward. The configuration of the PFT and PRT may be performed either by a network management system (NMS) or by any suitable signaling protocol.

The system and method disclosed in FIGS. 4-6 facilitate fast transition from a working mode to a protection mode in case of failure, because each node is already configured with the forwarding actions to be performed.

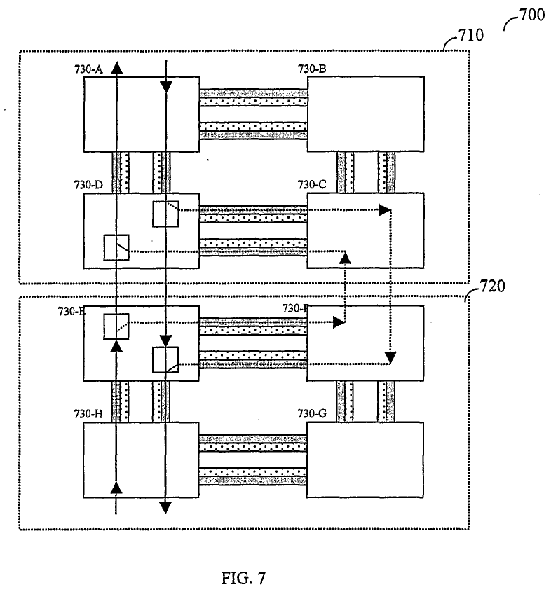

FIG. 7 shows a non-limiting illustration of a protection architecture for two MPLS rings 710 and 720 with a signal routed in the same direction in both rings (“dual ring protection”). Two interconnections between rings 710 and 720 can be arranged to provide protection of traffic crossing from one ring to the other. Rings 710 and 720 are shown to be interconnected at two nodes 730-D and 730-C in ring 710 and nodes 730-E and 730-F in ring 720. The topology operates such that a failure in either one of these nodes would not cause loss of any working traffic. This architecture is used for protecting the traffic crossing both rings. This architecture provides protection for all types of failures including, but not limited to, fiber cut, a node failure, or an equipment (module) failure.

In use, a given LSP traffic is transmitted at primary nodes (e.g., nodes 730-D and 730-E) either from ring 710 to ring 720 or vice versa. In case of failure in the interconnection path, the traffic is forwarded to the secondary node on the same ring by using a selective bridge means. For example, for LSP traffic traveling from ring 710 to 720, in case of failure this traffic is forwarded to a secondary node of ring 720, i.e., node C. Once the LSP traffic reaches the primary node 730-E in ring 720, the traffic is permanently merged from both directions: from the direction of the interconnecting node ring 710 and from the direction of the secondary node on ring 720.

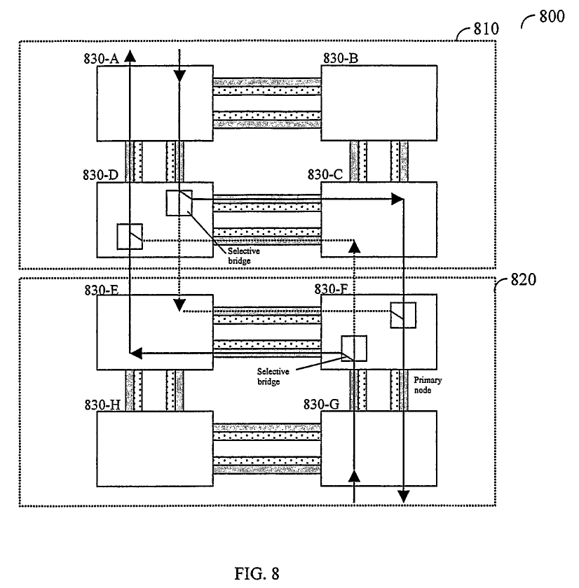

It should be noted by a person skilled in the art that the terms “primary node” and “secondary node” as used herein are not absolute and depend on the given LSP routing in normal conditions. For the LSPs routed in a clockwise direction, the right interconnecting node will be a “primary node”, while the left node will be a “secondary” node. For the LSPs routed normally in a counter-clockwise direction, the configuration is opposite. FIG. 8 provides an illustration for a protection architecture where a signal is routed in two rings 810 an 820 in opposite directions.

In the examples discussed above, rings are interconnected through two adjacent nodes. However, a more general topology may include intermediate nodes between the primary and secondary nodes. For the sake of simplicity, such a general topology is not described herein in detail. However, it would be appreciated by a person skilled in the art that the protection mechanisms described above are being capable of supporting such a general topology as well. It should be noted that a number of interconnection links other than two may exist between two rings. As well, the same ring may interconnect with several other rings at different nodes. Interconnection links are grouped in pairs and each pair has an assigned identification number.

In another embodiment of the present invention, there is provided a tunnel protection mechanism. A tunnel protection mechanism and techniques for establishing tunnels and tunneling packets are described in greater detail in the '464 application. The traffic transmitted over a MPLS ring could be one of the following types: normal traffic, unprotected traffic and extra traffic. Normal traffic is traffic that needs to be protected in case of protection switching. Unprotected traffic is a non-preemptable unprotected traffic (NUT), i.e., incoming traffic that should be transmit promptly to a destination node. Extra traffic means traffic that could be discarded in case of protection switching.

In order to differentiate between the various traffic types, multiple MPLS tunnels need to be established. Each tunnel aggregates LSPs of the same protection type. The MPLS ring bandwidth on each span is logically partitioned between four tunnels: working, protection, unprotected, and extra. The working tunnel carries normal traffic when no protection switch exists in the ring. The protection tunnel carries normal traffic in case there is a ring protection switch. The unprotected tunnel carries non-preemptable unprotected traffic and the extra tunnel carries extra traffic.

If one uses LSP tunnels, then each type of tunnel listed above should be established per each QoS. This would ensure that each service receives the QoS according to the service agreement during the protection switch as well. Specifically, working and protection tunnels are established between each pair of adjacent nodes and provide the ability to monitor each span at the MPLS layer. Tunnels are constantly monitored in both directions by use of MPLS OAM frames. Failures are may be detected using, for example, CC/FFD and FDI/BDI OAM frames over single hop tunnel. A protection tunnel is a tunnel with known labels built over the protection ring in a closed loop manner.

When the protection switching occurs, packets of all LSPs transmitted through the working tunnel are switched to the protection tunnel. This operation is performed for all LSPs at once by replacing the outmost MPLS label (see “stacking” discussion below) from working tunnel label to protection tunnel label and sending the packets in the direction opposite to the normal one. In an embodiment of the present invention, MPLS label stacking is used to distinguish between the protection tunnel (to be passed transparently at intermediate nodes) and working tunnels. A detailed description of the label stacking mechanism may be found in http://www.ietf.org/rfc/rfc3032.txt, which is incorporated herein by reference.

In steering ring applications, working tunnels carry normal traffic when no protection switching exists in the ring. Protection tunnels carry normal traffic in case of a protection switching event in the ring. Under normal conditions, the source node transmits a given LPS traffic in a selected direction over the working tunnel. When the traffic reaches its destination, a sink node drops it from the ring. At each intermediate node, a given LSP traffic is passed though by forwarding the packets from a working tunnel on certain span to a working tunnel on the next span. When the protection switching occurs, the source node transmits the given LSP traffic in an opposite direction over the protection tunnel. When the traffic reaches its destination, the destination node drops it from the ring. At each intermediate node, a given LSP traffic is passed through by switching from a protection tunnel on a certain span to a protection tunnel on the next span. Further, at each intermediate node, the outmost label is popped from the label stack and a new label corresponding to the working or protection tunnel (depending on the protection status) is pushed.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1. In a ring network that includes a working transport medium and a protection transport medium, a method for protecting multicast traffic of a label switched path (LSP) established between a source node and a destination node through at least one intermediate node, the method comprising the steps of:
a. pre-configuring each node with a respective table operative to instruct the node on actions to be taken upon detection of a failure in the ring network; and
b. upon detection of the failure in the ring network, causing at least one node to perform a protection action on the multicast traffic according to its respective preconfigured instructions.

2. The method of claim 1, wherein the step of pre-configuring includes:
i. pre-configuring the source node with a protection routing table (PRT) operative to reroute the multicast traffic, and
ii. pre-configuring each intermediate node and the destination node with a respective protection forwarding table (PFT) operative to provide at least an alternative forwarding action.

3. The method of claim 2, wherein the step of causing at least one node to perform a protection action is preceded by the step of
c. sending, by a node that detects the failure, a failure status message to each other node.

4. The method of claim 3, wherein the step of sending includes:
i. by the source node and according to its PRT, rerouting the multicast traffic and,
ii. by each intermediate node and according to its respective PFT, performing a forwarding action on the multicast traffic.

5. The method of claim 4, wherein the rerouting of the multicast traffic by the source node includes switching the traffic to the protection transport medium.

6. The method of claim 3, wherein the detection of the failure is performed by an immediate neighboring node adjacent to a location of the failure, and wherein the step of sending by a node that detects the failure includes sending a failure location message by the immediate neighboring node.

7. The method of claim 5, wherein the rerouting of the multicast traffic by the source node further includes performing an operation selected from the group consisting of uni-casting traffic and bi-casting traffic.

8. The method of claim 4, wherein the performing a forwarding action on the multicast traffic includes performing a forwarding action selected from the group consisting of a drop action, a forward action and a drop-and-forward action.

9. The method of claim 7, wherein the performing of a drop-and-forward action includes:
A. replicating data packets of the multicast traffic internally in an intermediate node that receives the packets;
B. sending the replicated data packets to at least one customer site connected to the respective intermediate node; and
C. sending the data packets to a next node connected to the respective intermediate node.

10. The method of claim 7, wherein the performing a drop action includes: sending data packets of the multicast traffic to at least one customer site connected to an intermediate node or to the destination node.

11. The method of claim 7, wherein the performing of a forward action includes sending data packets of the multicast traffic to a neighboring node the ring network.

12. The method of claim 2, wherein the step of pre-configuring includes pre-configuring by an operator using a mechanism selected from the group consisting of a network management system, a command line interface and a signaling protocol.

13. The method of claim 2, wherein the step of pre-configuring the source node with a PRT includes pre-configuring the PRT with at least one alternate path for the LSP.

14. The method of claim 2, wherein the step of pre-configuring each intermediate node and the destination node with a respective PRT pre-configuring a forwarding action to be performed for each instance of failure.

15. The method of claim 1, further comprising the steps of:
d. creating at least one protection tunnel over the protection transport medium to carry normal traffic;
e. creating at least one working tunnel over said working transport to carry multicast traffic;
and wherein the step of causing at least one node to perform a protection action on the multicast traffic includes transmitting the multicast traffic in opposite direction from the failure location over the protection tunnel, and dropping the multicast traffic at the destination node.

16. In a ring network that includes a working transport medium and a protection transport medium, a system for protecting multicast traffic of a label switched path (LSP) established between a source node and a destination node through at least one intermediate node, the system comprising;
a. at least one pre-configured table included in each node of the ring network and operative to instruct the node on actions to be taken upon detection of a failure in the ring network; and
b. a mechanism for performing at least at one node a protection action on the multicast traffic according to instructions in its respective pre-configured table.

17. The system of claim 16, wherein the at least one preconfigured table includes, for the source node, a protection routing table (PRT) operative to reroute the multicast traffic, and for each intermediate and destination node a protection forwarding table (PFT) operative to provide an alternative forwarding action.

18. The system of claim 17, wherein the source node PRT instructions include instructions to perform an operation selected from the group consisting of uni-casting traffic and bi-casting traffic.

19. The system of claim 17, wherein the intermediate node PFT instructions include a forwarding action selected from the group consisting of a drop action, a forward action and a drop-and-forward action.

20. The system of claim 17, wherein the ring network is operative to use a label switching protocol for transferring data packets.

21. The system of claim 20, wherein the label switching protocol includes a multi-protocol label switching (MPLS) protocol.

22. The system of claim 17, wherein the ring network is selected from the group consisting of a unidirectional ring network and a bidirectional ring network.

23. In a ring network that includes a working transport medium and a protection transport medium, a method for protecting multicast traffic of a label switched path (LSP) established between a source node and a destination node through at least one intermediate node, the method comprising the steps of:
a. assigning a unique LSP label for the LSP;
b. configuring each intermediate node in the ring network to transparently transfer data packets of the multicast traffic, each data packet including the unique LSP label; and
c. upon detecting a failure in the ring network, switching the data packets to a protection transport medium.

24. The method of claim 23, wherein the detecting a failure in the ring network is performed by a first node adjacent to a location of the failure.

25. The method of claim 23, wherein the ring network is operative to use a label switching protocol for transferring the data packets over the ring communications network.

26. The method of claim 25, wherein the label switching protocol includes a multi-protocol label switching (MPLS) protocol.

27. The method of claim 23, wherein the ring network is selected from the group consisting of a unidirectional ring network and a bidirectional ring network.
